(19) United States
(12) Patent Application Publication
(10) Pub. No.: US 2013/0212302 A1
(43) Pub. Date: Aug. 15, 2013

(54) DISK ARRAY APPARATUS

(71) Applicants: Takakatsu Mizumura, Chigasaki (JP); Hiroshi Suzuki, Sagamihara (JP); Tetsuya Inoue, Odawara (JP); Yosuke Nakayama, Odawara (JP)

(72) Inventors: Takakatsu Mizumura, Chigasaki (JP); Hiroshi Suzuki, Sagamihara (JP); Tetsuya Inoue, Odawara (JP); Yosuke Nakayama, Odawara (JP)

(73) Assignee: HITACHI, LTD., Tokyo (JP)

(21) Appl. No.: 13/394,694

(22) PCT Filed: Feb. 9, 2012
(86) PCT No.: PCT/JP2012/000877

§ 371 Date: Mar. 7, 2012

(51) Int. Cl. G06F 3/00

(52) U.S. Cl. 710/5

(57) ABSTRACT

The difference in the form of connectors connected to data transmission cables is absorbed. A disk array apparatus has a plurality of disk units for executing data input/output processing on storage devices in accordance with a control command from a disk controller; wherein an interface substrate is placed at each disk unit and the interface substrate has a plurality of cable connection connectors to be connected to cables; and a first cable connection connector is connected to a local disk unit, where the relevant connector is placed, via a first data transmission cable; and a second cable connection connector is connected to an adjacent disk unit, which is located adjacent to the local disk unit, or an interface substrate which is placed in the adjacent disk unit, via a second data transmission cable; and these cable connection connectors are configured as connectors in mutually different forms.

### TECHNICAL FIELD

The present invention relates to a disk array apparatus in which a plurality of disk units for executing data input/output processing on storage devices are connected to each other via cables.

### BACKGROUND ART

The disk array apparatus includes, for example, for example, a disk controller for sending/receiving information to/from a host computer and a plurality of disk units having expanders for executing data input/output processing on storage devices in accordance with a control command from the disk controller; and the respective disk units are connected via cables. Incidentally, a disk array apparatus in which an option device equipped with a specific function can be mounted in a disk drive slot is suggested (see PTL 1).

With this type of disk array apparatus, each disk unit is mounted in an empty space of a standard rack and the disk units are connected via cables. Under this circumstance, a disk unit(s) can be added according to the scale of the relevant system by serially connecting each disk unit via a cable.

### CITATION LIST

### Patent Literature

PTL 1: Japanese Patent Application Laid-Open (Kokai) Publication No. 2004-265010

### SUMMARY OF INVENTION

### Technical Problem

However, regarding types of cables placed between the disk units, only cables that are adaptable to expanders in the disk units can be used; and regarding types of connectors for connecting the cables, only connectors that are adaptable to expander substrates in the disk units can be used. Therefore, in order to newly use a cable having a protocol or connector which is not compatible with the expanders in the disk units, it is necessary to equip the disk unit with an expander substrate on which an expander adaptable to the new cable is mounted.

In this case, it is possible to adapt to the new cable by equipping the disk unit with the expander substrate on which the expander adaptable to the new cable is mounted. However, the new cable will not necessarily be used; and in consideration of a case where the new cable will not be used, a high cost is expected. Furthermore, when the new cable is used, even if the expander substrate is replaced with the new expander substrate, a problem of performance degradation caused by the replacement work occurs.

Specifically speaking, a SAS (Serial Attached SCSI) copper cable is used as an interface between currently mainstream disk units. However, as the cable length of the copper cable increases, signals degrade, thereby limiting a maximum cable length. On the other hand, if a SAS optical cable is used instead of the copper cable, the cable length can be increased to dozens of times as long as the copper cable.

However, the copper cable and the optical cable are not compatible with each other and the optical cable cannot be used without any change, instead of the copper cable, in the disk unit to which the copper cable is connected. Additionally, when another copper cable is to be used in the disk unit to which the copper cable is connected, that other copper cable cannot be used depending on the shape of a connector.

Furthermore, it is disclosed regarding the storage apparatus described in PTL 1 that another disk array apparatus is used as a backup apparatus and information about the disk array apparatus is reported to an external management device; however, PTL 1 does not disclose that the difference in the shape of connectors is absorbed and a data path is extended by embedding an interface substrate in the data path.

It is an object of the present invention to provide a disk array apparatus capable of absorbing the difference in the form of connectors connected to data transmission cables.

### Solution to Problem

In order to solve the above-described problem, a disk array apparatus according to the present invention has a plurality of disk units for executing data input/output processing on storage devices in accordance with a control command, wherein an interface substrate for data transfer is placed at at least one disk unit; the interface substrate has plurality of cable connection connectors to be connected to cables; a first cable connection connector is connected to a local disk unit, in which the relevant connector is placed, via a first data transmission cable; a second cable connection connector is connected to an adjacent disk unit, which is located adjacent to the local disk unit, or an interface substrate which is placed in the adjacent disk unit, via a second data transmission cable; and the respective cable connection connectors are configured as connectors in mutually different forms.

### Advantageous Effects of Invention

According to the present invention, the difference in the form of connectors connected to data transmission cables can be absorbed.

### BRIEF DESCRIPTION OF DRAWINGS

FIG. 1 is an overall configuration diagram of a storage system to which the present invention is applied.

FIG. 2 is a perspective view showing the exterior appearance of a disk array apparatus.

FIG. 3 is a configuration diagram of disk units.

FIG. 4 is a configuration diagram of a copper-optical conversion interface substrate.

FIG. 5 is a configuration diagram of a copper-optical conversion interface substrate.

FIG. 6 is a configuration diagram of a copper-copper conversion interface substrate.

FIG. 7 is a configuration diagram of a copper-copper conversion interface substrate.

FIG. 8 is a configuration diagram of a copper-copper conversion interface substrate.

FIG. 9 is a system configuration diagram using the interface substrates.

FIG. 10 is a connection diagram of an upper-side interface substrate.

FIG. 11 is another connection diagram of an upper-side interface substrate.

FIG. 12 is a connection diagram of a lower-side interface substrate.

FIG. 13 is another connection diagram of a lower-side interface substrate.

FIG. 14 is a flowchart for explaining interface substrate initialization processing.

FIG. 15 is a flowchart for explaining processing of a system according to a first embodiment.

FIG. 16 is a system configuration diagram using interface substrates according to a second embodiment.

FIG. 17 is a flowchart for explaining processing according to the second embodiment.

FIG. 18 is a system configuration diagram using interface substrates according to a third embodiment.

### DESCRIPTION OF EMBODIMENTS

An embodiment of the present invention will be explained based on the attached drawings.

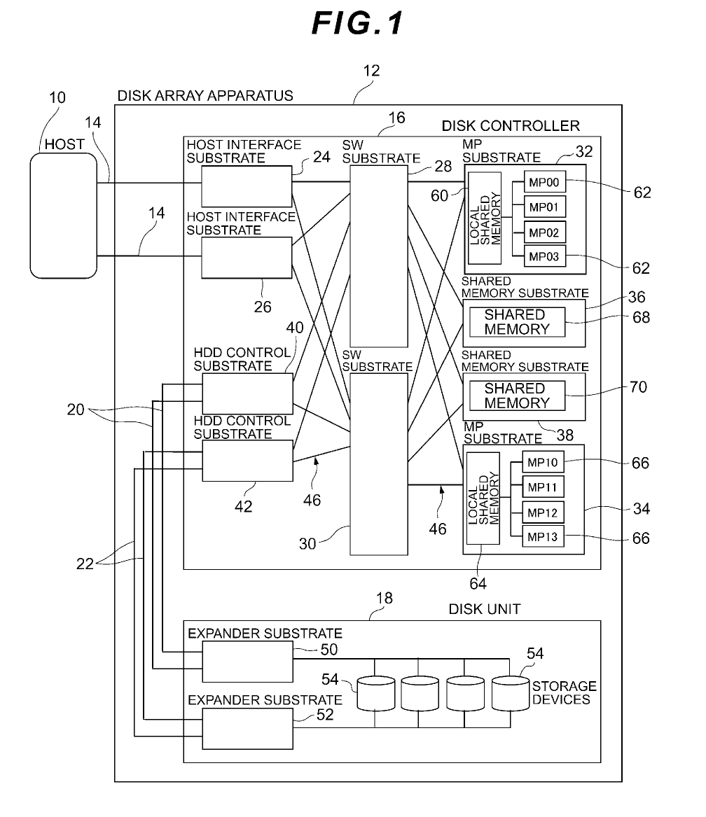

FIG. 1 is an overall configuration of a storage system according to an embodiment of the present invention. Referring to FIG. 1, the storage system includes a host computer (hereinafter sometimes referred to as the host) 10 and a disk array apparatus 12; and the host 10 and the disk array apparatus 12 are connected to each other via a network 14.

The host 10 is a computer device equipped with information processing resources such as a CPU (Central Processing Unit), a memory, and an input/output interface and is configured as, for example, a personal computer, a workstation, or a mainframe. The host 10 sends a control command such as a write request or a read request to the disk array apparatus 12 via the network 14. When doing so, the host 10 can access logical volumes of the disk array apparatus 12 by sending an access request such as a write request or a read request, which designates the logical volumes provided by the disk array apparatus 12, as a control command to the disk array apparatus 12.

The disk array apparatus 12 is composed of a disk controller 16 and a plurality of disk units 18. The disk controller 16 is connected to each disk unit 18 via cables 20, 22. Each cable 20, 22 is a data transmission cable and is composed of, for example, a SAS copper cable.

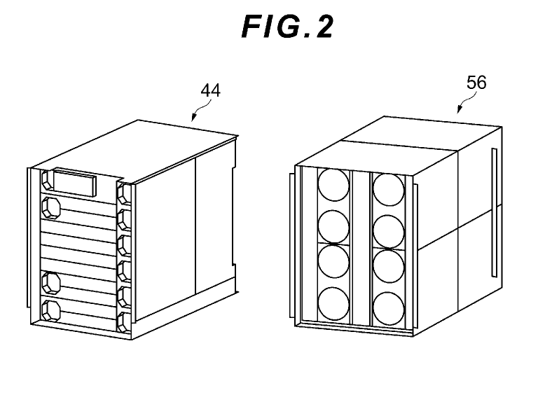

The disk controller 16 is composed of a plurality of host interface substrates 24, 26, a plurality of switch substrates 28, 30, a plurality of MP (Micro Processor) substrates 32, 34, a plurality of shared memory substrates 36, 38, and a plurality of HDD (Hard Disk Drive) control substrates 40, 42; and is placed in a disk controller chassis 44 as shown in FIG. 2.

Each disk unit 18 is composed of a plurality of expander substrates 50, 52 and a plurality of storage devices 54 and is placed in a disk unit chassis 56 as shown in FIG. 2.

Storage devices such as HDDs, semiconductor memory devices, optical disk devices, magneto-optical disk devices, magnetic tape devices, and flexible disk devices can be used as the storage devices 54.

If the HDDs are to be used as the storage devices, for example, SCSI (Small Computer System Interface) disks, SATA (Serial ATA) disks, ATA (AT Attachment) disks, and SAS (Serial Attached SCSI) disks can be used.

If the semiconductor memory devices are to be used as the storage devices, for example, SSD (Solid State Drive), FeRAM (Ferroelectric Random Access Memory), MRAM (Magnetoresistive Random Access Memory), phase change memory (Ovonic Unified Memory), and RRAM (Resistance Random Access Memory) can be used.

Furthermore, each storage device 54 can constitute a RAID (Redundant Array of Inexpensive Disks) group such as RAID4, RAID5, or RAID6 and each storage device 54 can be divided into a plurality of RAID groups. Under this circumstance, a plurality of logical units (hereinafter sometimes referred to as LU [Logical Units]) or a plurality of logical volumes can be formed in a physical storage area of each storage device 54. Also, if a RAID group is formed in each storage device 54, a grouped storage area can be divided into LDEVs (Logical Devices), which are logical storage areas, and the group can be allocated to the divided LDEVs.

Each host interface substrate 24, 26 is connected to the host 10 via the network 14 and also collected to the switch substrates 28, 30 via an internal network 46. Each host interface substrate 24, 26 has a host interface (not shown) for receiving a read command or a write command as a control command from the host 10 and sending/receiving user data to/from the host 10.

Each switch substrate 28, 30 is connected via the internal network 46 to each host interface substrate 24, 26, MP substrate 32, 34, shared memory substrate 36, 38, and HDD control substrate 40, 42 and has a switch unit (not shown) for executing switching processing for sorting control commands and user data to each substrate.

The MP substrate 32 is equipped with a local shared memory 60 and four micro-processors 62; and the MP substrate 34 is equipped with a local shared memory 64 and four microprocessors 66. The local shared memory 60, 64 temporarily stores data sent from the host 10 and also stores information used and shared between the micro-processors 62 or between the microprocessors 66. Each microprocessor 62, 66 controls processing of the control commands and data transfer.

The shared memory substrate 36, 38 is equipped with a shared memory 68, 70. The shared memory 68, 70 stores user data and control commands and also stores management information such as management tables.

The HDD control substrate 40, 42 has an SAS controller (not shown) for transferring the user data and the control commands to each disk unit 18, receiving the user data from each disk unit 18, and transferring the received data to the switch substrates 28, 30.

Incidentally, referring to FIG. 1, two substrates of each substrate type are mounted in the disk controller 16; however, three or more substrates of each substrate type may be mounted depending on the system configuration.

The expander substrate 50, 52 is equipped with an expander (not shown) that functions as a control unit for executing data input/output processing on the storage devices 54 in accordance with a control command from the disk controller 16 and controlling data transfer to the storage devices 54 or the disk controller 16.

Under this circumstance, if the disk controller 16 receives a write command and write data for a certain LDEV from the host 10 in the process of managing the user data, which are stored in the storage devices 54, on an LDEV basis, for example, a host interface of the host interface substrate 24 executes processing for receiving the write command and user data sent from the host 10 and writes the received write command and user data to the shared memory 68 of the shared memory substrate 36 via the switch substrate 28.

Subsequently, if any of the microprocessors 62 detects the write command and user data which have been written to the shared memory 68, the microprocessor 62 executes control to transfer the write command and user data to the disk unit 18 via the switch substrate 28 and the HDD control substrate 40. The user data transferred to the disk unit 18 is written to the storage devices 54 via the expander in the expander substrate 50.

Incidentally, each microprocessor 62 refers to the management tables stored in the shared memory 68 by means of polling and the microprocessor 62 having ownership of the LDEV, to which the command was written, among the four microprocessors 62 executes processing of the command.

On the other hand, if the disk controller 16 receives a read command from the host 10, for example, if the host interface of the host interface substrate 26 searches the shared memory 70 based on the received read command and read data designated by the read command exists in the shared memory 70, the host interface transfers the read data existing in the shared memory 70 to the read data; and if the read data does not exist in the shared memory 70, the host interface executes processing for writing the read command to the shared memory 70.

Under this circumstance, if each microprocessor 66 refers to the shared memory 70 by means of polling and a read command to be processed exists in the shared memory 70, any one of the microprocessors 66 executes processing for transferring the read command to the disk unit 18 via the switch substrate 30 and the HDD control substrate 40 and reading read data from the storage devices 54 and stores the read data, which has been read, in the shared memory 70. The read data stored in the shared memory 70 is transferred to the host 10 by the host interface of the host interface substrate 26.

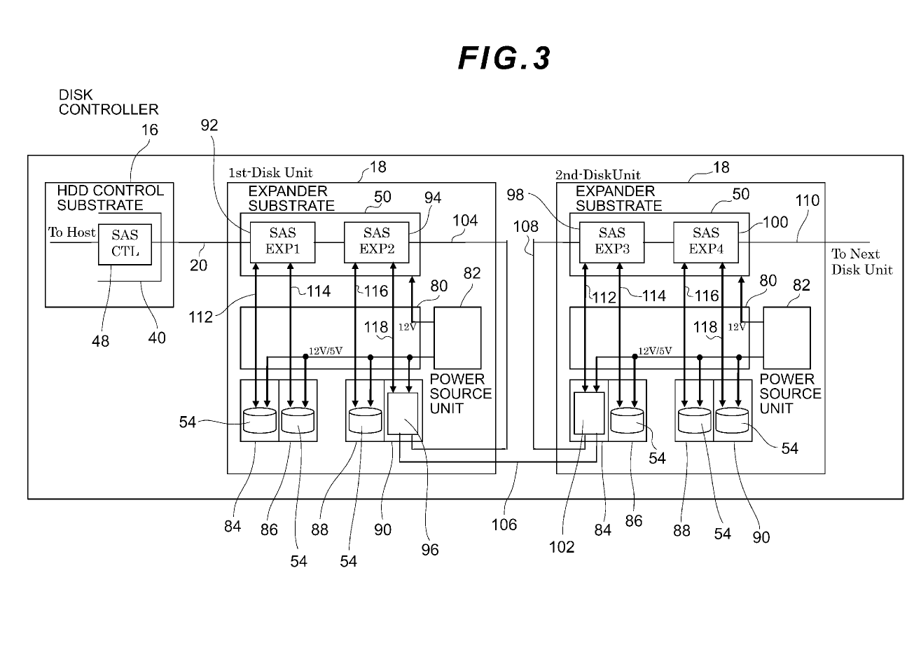

Next, FIG. 3 shows a specific configuration diagram of the disk units. Referring to FIG. 3, a first disk unit 18 among the plurality of disk units 18 is composed of an expander substrate 50, a back board 80, a power source unit 82, and a plurality of HDD slots 84, 86, 88, 90.

Under this circumstance, the expander substrate 50 of the first disk unit 18 is equipped with a first expander 92 and a second expander 94 as SAS expanders; and the storage device 54 is mounted in each HDD slot 84, 86, 88 and a first interface substrate 96 is mounted in the HDD slot 90.

On the other hand, the expander substrate 50 of a second disk unit 18 is equipped with a third expander 98 and a fourth expander 100; and a second interface substrate 102 is mounted in the HDD slot 84 and the storage device 54 is mounted in each HDD slot 86, 88, 90. Incidentally, the first interface substrate 96 is mounted in the HDD slot 90, which is an empty slot, and the second interface substrate 102 is mounted in the HDD slot 84 which is an empty slot.

The first expander 92 is connected via a SAS copper cable 20 to a SAS controller 48 in the HDD control substrate 40 and the second expander 94 is connected via a SAS copper cable 104 to the first interface substrate 96. The first interface substrate 96 and the second interface substrate 102 are connected via a SAS optical cable 106 and the second interface substrate 102 and the third expander 98 are connected via a SAS copper cable 108. The fourth expander 100 is connected via a SAS copper cable 110 to another disk unit (third disk unit) 18.

Furthermore, the first expander 92 is connected via SAS narrow links 112, 114 to the storage devices 54 and the second expander 94 is connected via a SAS narrow link 116 to the storage device 54 and is also connected via a SAS narrow link 118 to the first interface substrate 96. Furthermore, the third expander 98 is connected via the narrow link 112 to the second interface substrate 102 and is also connected via the narrow link 114 to the storage device 54. The fourth expander 100 is connected via the narrow link 116 to the storage device 54 and is also connected via the narrow link 118 to the storage device 54. Under this circumstance, each expander 92, 94, 98, 100 executes data input/output processing on the storage devices 54 in accordance with a control command from the disk controller 16; and a SAS address is set to each expander 92, 94, 98, 100 in order to uniquely identify each expander.

Incidentally, 12-volt or 5-volt power is supplied to each expander substrate 50 from the power source unit 82 via the back board 80. Also, 12-volt or 5-volt power is supplied to each storage device 54 and each interface substrate 96, 102 from the power source unit 82 via the back board 80. Specifically speaking, the same power as that used by the storage device 54 is supplied to each interface substrate 96, 102 from the power source unit 82. Therefore, the interface substrates 96, 102 can operate in all disk array apparatuses as long as the disk array apparatus has HDD slots.

Under the above-described circumstance, the first interface substrate 96 has a function converting a protocol for an electric signal, which transmits through the copper cable 104, into a protocol for an optical signal, which transmits through the optical cable 106, and the conversion from the electric signal to the optical signal is realized by the optical cable 106. Furthermore, the second interface substrate 102 has a function converting the protocol for the electric signal, which transmits through the optical cable 106, into the protocol for the electric signal, which transmits through the copper cable 108 and the conversion from the electric signal to the optical signal is realized by the optical cable 106.

Therefore, even if the disk unit 18, to which the copper cable 104 is connected, and the disk unit 18, to which the copper cable 108 is connected, are placed at locations away from each other, the first disk unit 18 and the second disk unit 18 can be connected via the optical cable 106 by mounting the first interface substrate 96 in the first disk unit 18, mounting the second interface substrate 102 in the second disk unit 18, and connecting the interface substrate 96 and the interface substrate 102 via the optical cable 106. In this case, the interface substrates 96, 102 function as copper-optical conversion interface substrates.

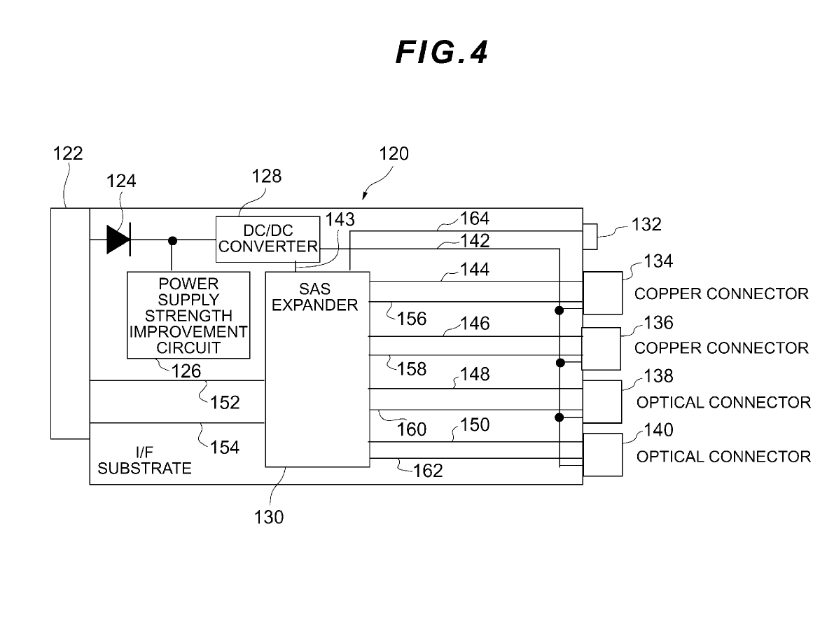

Next, FIG. 4 shows a configuration diagram of a copper-optical conversion interface substrate. Referring to FIG. 4, a copper-optical conversion interface 120 is an interface substrate used as the interface substrate 96 or the interface substrate 102 and is composed of an HDD connector 122, a diode 124, a power supply strength improvement circuit 126, a DC/DC converter 128, a SAS expander 130, an LED (Light Emitting Diode) 132, a SAS copper connector 134 (a connector for connecting a copper cable will be hereinafter referred to the copper connector), a SAS copper connector 136, a SAS optical connector 138 (a connector for connecting an optical cable will be hereinafter referred to the optical connector), and a SAS optical connector 140. Under this circumstance, a SAS address is set to the expander 130 in order to uniquely identify the expander 130. Furthermore, each connector accommodates a register for retaining cable information to specify, for example, the form of each connector.

The copper connector 134, 136 and the optical connector 138, 140 are configured as cable connection connectors in mutually different forms. The form of a connector herein used means the shape of the connector or the type of a signal (electric signal or optical signal) using the connector as a transmission medium. The copper connector 134 and the copper connector 136 are connectors for transmitting the electric signal and are configured as copper connectors in mutually different shapes for connecting a copper cable. The optical connector 138 and the optical connector 140 are connectors for transmitting the optical signal and configured as optical connectors in mutually different shapes for connecting the optical cable.

With the interface substrate 120, 5-volt or 12-volt power is supplied from the power source unit 82 via the diode 124 to the power supply strength improvement circuit 126 and the DC/DC converter 128. Incidentally, a battery may be used instead of the power supply strength improvement circuit 126. The DC/DC converter 128 converts the input voltage into a specified voltage and supplies power of the specified voltage via a power supply line 142 to each connector 134 to 140 and via a power supply line 143 to the expander 130.

Two ports for copper cables, two ports for optical cables, and two ports for the back board are assigned to the expander 130. A SAS wide link 144, 146 is connected to each port for the copper cable and a SAS wide link 148, 150 is connected to each port for the optical cable. A SAS narrow link 152, 154 is connected to each port for the back board. Furthermore, setting control lines 156, 158, 160, 162 are connected to a plurality of general purpose pins assigned to the expander 130.

Specifically speaking, the wide link 144 and the control line 156 are connected to the copper connector 134; and the wide link 146 and the control line 158 are connected to the connector 136. The wide link 148 and the control line 160 are connected to the optical connector 138; and the wide link 150 and the control line 162 are connected to the optical connector 140. Incidentally, the expander 130 is connected to the LED 132 via a control line 164 for controlling lighting-up of the LED 132.

Under this circumstance, the expander 130 has a protocol conversion function (function as a protocol converter) converting a signal, which is input from the copper connector 134 or the copper connector 136 via the wide link, from the protocol for the electric signal into the protocol for the optical signal and outputting the converted signal via the wide link to the optical connector 138 or the optical connector 140; and also has a function as a signal amplifier for amplifying the signal input from the copper connector 134 or the copper connector 136. Furthermore, the expander 130 has a protocol conversion function converting a signal, which is input from the optical connector 138 or the optical connector 140 via the wide link, from the protocol for the optical signal into the protocol for the electric signal and outputting the converted signal via the wide link to the copper connector 130 or the copper connector 136. Furthermore, the expander 130 also has a function as a signal amplifier for amplifying the signal which is input from the optical connector 138 or the optical connector 140.

The interface substrate 120 having the above-described configuration can be used as the interface substrate 96 or the interface substrate 102. For example, if the interface substrate 120 is used as the interface substrate 96, the copper cable 104 is connected to the copper connector 134 and the optical connector 138 is connected to the optical cable 106. If the interface substrate 120 is used as the interface substrate 102, the optical cable 106 can be connected to the optical connector 138 and the copper cable 108 can be connected to the copper connector 134.

Under the above-described circumstance, the difference in the shape of copper connectors can be absorbed by selecting a copper connector in the same shape as that of a connector connected to a copper cable from the copper connectors 134, 136 and coupling the selected copper connector to the copper connector connected to the copper cable. The difference in the shape of optical connectors can be absorbed by selecting an optical connector in the same shape as that of a connector connected to an optical cable from the optical connectors 138, 140 and coupling the selected optical connector to the optical connector connected to the optical cable.

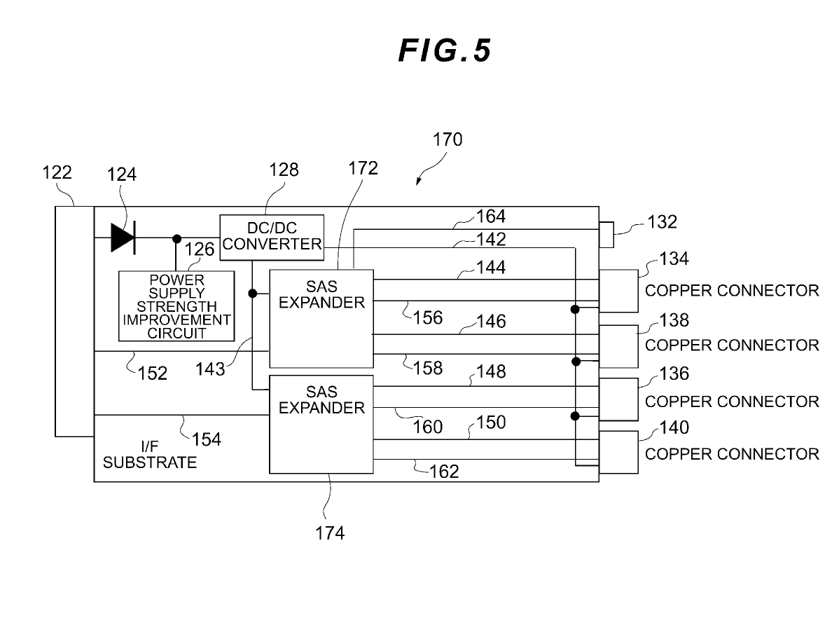

Next, FIG. 5 shows another configuration diagram of another copper-optical conversion interface substrate. Referring to FIG. 5, a copper-optical conversion interface substrate 170 is an interface substrate, in which SAS expanders 172, 174 are used instead of the expander 130, and other components are the same as those of the interface substrate 120. The expander 172, 174 is provided with one port for a copper cable, one port for an optical cable, and one port for connection to the back board (for a narrow link). Each expander 172, 174 has the same functions as those of the expander 130, for example, the protocol conversion function converting the protocol for the electric signal into the protocol for the optical signal or converting the protocol for the optical signal into the protocol for the electric signal and the function as the signal amplifier for amplifying the input signal.

The interface substrate 170, like the interface substrate 120, can be used as the interface substrate 96 or the interface substrate 102.

Under this circumstance, the difference in the shape of copper connectors can be absorbed by selecting a copper connector in the same shape as that of a connector connected to a copper cable from the copper connectors 134, 136 and coupling the selected copper connector to the copper connector connected to the copper cable. The difference in the shape of optical connectors can be absorbed by selecting an optical connector in the same shape as that of a connector connected to an optical cable from the optical connectors 138, 140 and coupling the selected optical connector to the optical connector connected to the optical cable.

Under the above-described circumstance, if a power failure occurs in one HDD of a RAID group constituting, for example, 3D (data)+1P (parity) in the disk array apparatus and a short circuit occurs within this HDD, there is a possibility that the interface substrate 96 or the interface substrate 102 may temporarily suffer a power failure. If the interface substrate 96 or 102 enters a momentary stopped state due to the power failure, this may cause a blockage of a path which passes through the interface substrate 96 or 102, significant performance degradation, or a state of no redundancy and then bring the system down.

So, in this embodiment, for example, the interface substrate 96 or 102 is equipped with the power supply strength improvement circuit 126 to back up the power source so that the interface substrate 96 or 102 will not detect a power failure while the power supply to the storage device, where the power failure occurred, is stopped, that is, until the failure at a power source boundary is recovered. Therefore, it is possible to prevent the path blockage of the interface substrate 96, 102 due to the power failure of the storage devices 54.

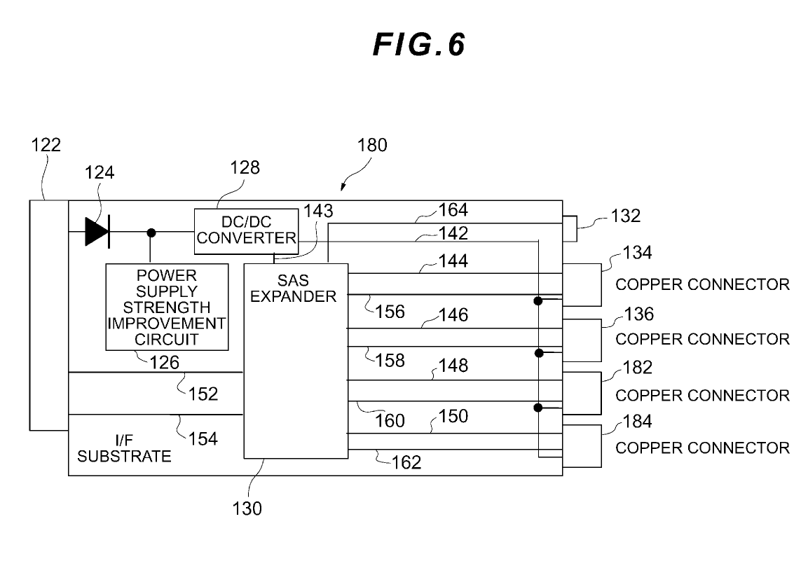

Next, FIG. 6 shows a configuration diagram of a copper-copper conversion interface substrate. Referring to FIG. 6, a copper-copper conversion interface substrate 180 is an interface substrate in which SAS copper connectors 182, 184 are used instead of the optical connectors 138, 140 and other components are the same as those shown in FIG. 4.

Under this circumstance, the respective copper connectors 134, 136, 182, 184 are configured as cable connection connectors in mutually different shapes.

In this case, the difference in the shape of the connectors can be absorbed by selecting a copper connector in the same shape as that of a copper connector connected to a copper cable from among the copper connectors 134, 136, 182, 184 and coupling the selected copper connector to the copper connector connected to the copper cable. It is also possible to prevent degradation of the signal quality by amplifying the electric signal at the expander 130.

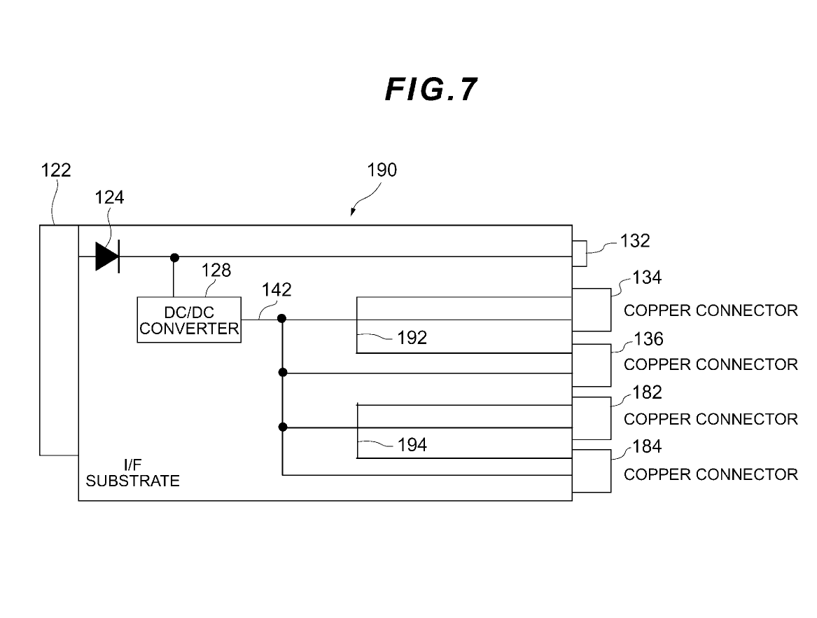

Next, FIG. 7 shows another configuration diagram of a copper-copper conversion interface substrate. Referring to FIG. 7, a copper-copper conversion interface substrate 190 is an interface substrate in which the power supply strength improvement circuit 126 and the expander 130 are removed from the interface substrate 180, the wide link 144 and the wide link 146 are connected to each other to constitute a wide link 192, and the wide link 148 and the wide link 150 are connected to each other to constitute a wide link 194; and other components are the same as those of the interface substrate 180 shown in FIG. 6.

In this case, the difference in the shape of the connectors can be absorbed by selecting a copper connector of the same shape as that of a connector connected to a copper cable from among the copper connectors 134, 136, 182, 184 and coupling the selected copper connector to the copper connector connected to the copper cable. Furthermore, the degradation of the signal quality can be prevented by amplifying the electric signal at the expander 130. Also, since the interface substrate 190 is not equipped with the expander 130, it is possible to construct the interface substrate at lower cost than the interface substrate 180.

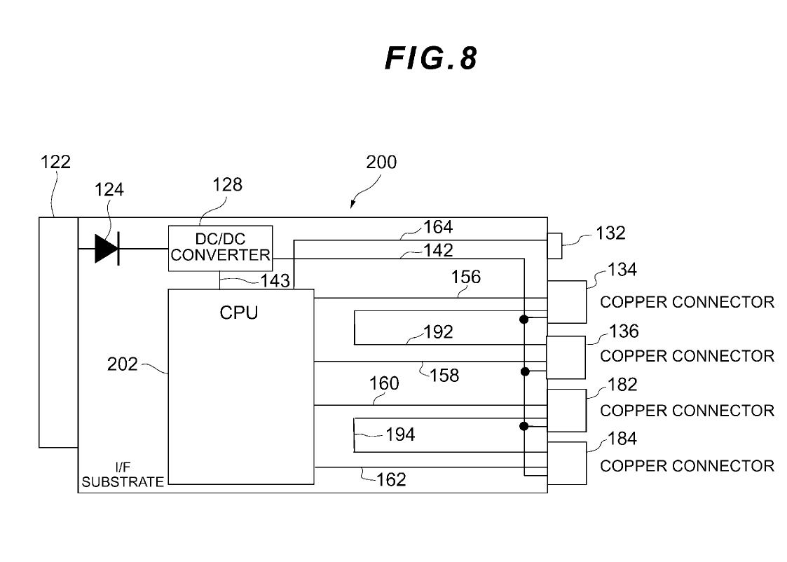

Next, FIG. 8 shows another configuration diagram of a copper-copper conversion interface substrate. Referring to FIG. 8, a copper-copper conversion interface substrate 200 is an interface substrate in which a microprocessor 202 such as a CPU is mounted on the interface substrate 190 shown in FIG. 7 and the microprocessor 202 and each copper connector 134, 136, 182, 184 are connected via a setting control line 156, 158, 160, 162; and other components are the same as those of the interface substrate 190 shown in FIG. 7.

The microprocessor 202 can perform various setting operation on each copper connector 134, 136, 182, 184 via the control line 156 to 162.

In this case, the difference in the shape of the connectors can be absorbed by selecting a copper connector of the same shape as that of a connector connected to a copper cable from among the copper connector 134, 136, 182, 184 and coupling the selected copper connector to the copper connector connected to the copper cable.

(System Configuration)

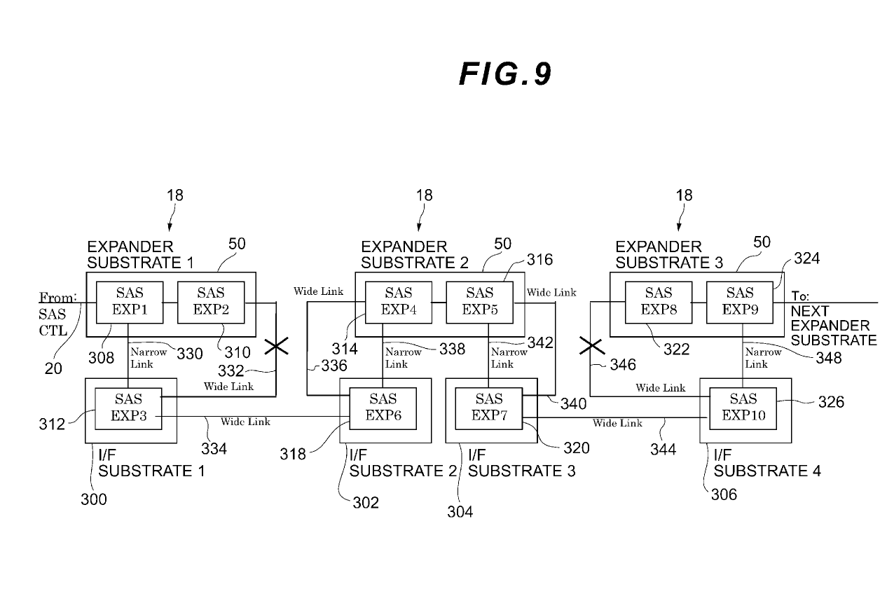

Next, FIG. 9 shows a system configuration diagram using the interface substrates. Referring to FIG. 9, a first disk unit 18 is composed of a first expander substrate 50 and a first interface substrate 300. A second disk unit 18 is composed of a second expander substrate 50, a second interface substrate 302, and a third interface substrate 304. A third disk unit 18 is composed of a third expander substrate 50 and a fourth interface substrate 306.

The first expander substrate 50 is equipped with a first expander 308 and a second expander 310; and the first interface substrate 300 is equipped with a third expander 312.

The second expander substrate 50 is equipped with a fourth expander 314 and a fifth expander 316; the second interface substrate 302 is equipped with a sixth expander 318; and the third interface substrate 304 is equipped with a seventh expander 320.

The third expander substrate 50 is equipped with an eighth expander 322 and a ninth expander 324; and the fourth interface substrate 306 is equipped with a tenth expander substrate 326.

The first expander 308 is connected via the copper cable 20 to the SAS controller 48 of the HDD control substrate 40 and also connected via a narrow link 330 to the third expander 312. The second expander 310 is connected via a wide link 332 to the third expander 312. The third expander 312 is connected via a wide link 334 to the sixth expander 318.

The fourth expander 314 is connected via a wide link 336 to the sixth expander 318 and also connected via a narrow link 338 to the sixth expander 318. The fifth expander 316 is connected via a wide link 340 to the seventh expander 320 and also connected via a narrow link 342 to the seventh expander 320. The seventh expander 320 is connected via a wide link 344 to the tenth expander 326.

The eighth expander 322 is connected via a wide link 346 to the tenth expander 326. The ninth expander 324 is connected via a narrow link 348 to the tenth expander 326.

Under this circumstance, the copper-optical conversion interface 120 or the copper-copper conversion interface substrate 180 is used as the first to fourth interface substrate 300, 302, 304, 306 equipped with the expander 312, 318, 320, 326.

If the narrow link 330 and the wide link 332 are used as routes forming paths in the first disk unit 18 in the above-described configuration, the plurality of routes, that is, the route using the narrow link 330 and the route using the wide link 332 are formed as routes to the third expander, so that SAS routing in a loop shape is formed, thereby causing a violation of the SAS standards. Similarly, if the wide link 346 and the narrow link 348 are used as routes forming paths in the third disk unit 18, the SAS routing in the loop shape is formed, thereby causing a violation of the SAS standards. In this case, it is possible to avoid the violation of the SAS standards by imposing restrictions when mounting the interface substrates 300, 306 in the HDD slots; however, the violation of the SAS standards can be also avoided by means of interface substrate initialization processing.

Initialization processing for avoiding the violation of the SAS standards during the interface substrate initialization processing will be explained below. Incidentally, the following explanation about this processing will be given by describing an interface substrate, which is located closer to the disk controller 16 among the interface substrates 300, 302, 304, 306, as an upper-side interface substrate and also describing an interface substrate, which is located at a position away from the disk controller 16, as a lower-side interface substrate.

In other words, the interface substrate 300 is defined as an upper-side interface substrate relative to the interface substrate 302 and the interface substrate 304 is defined as an upper-side interface substrate relative to the interface substrate 306. On the other hand, the interface substrate 302 is defined as a lower-side interface substrate relative to the interface substrate 300, and the interface substrate 306 is defined as a lower-side interface substrate relative to the interface substrate 304.

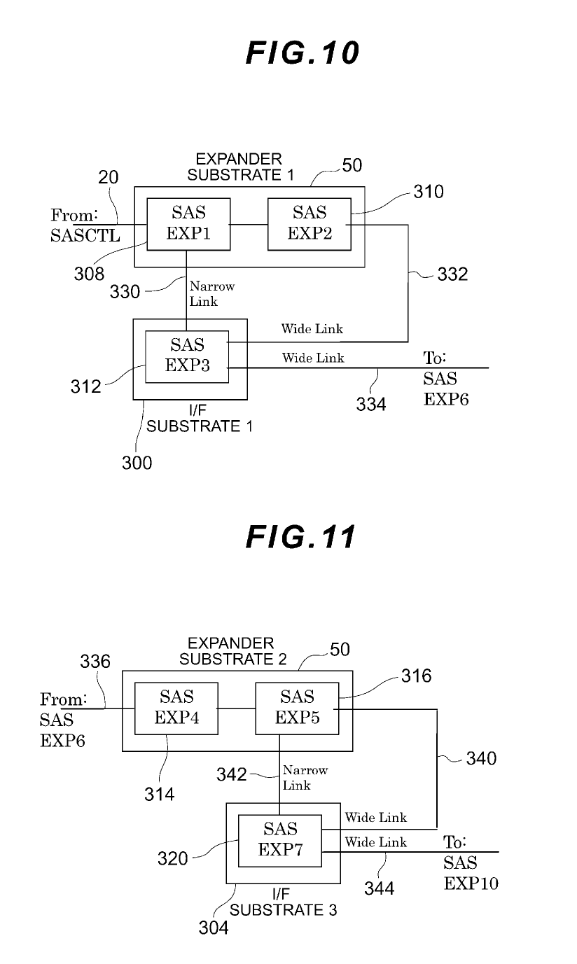

Next, FIG. 10 shows a connection diagram between an upper-side interface substrate and an expander substrate. Referring to FIG. 10, if the narrow link 330 and the wide link 332 are used as routes forming paths, the SAS routing in the loop shape is formed, thereby causing a violation of the SAS standards. Therefore, when activating the third expander 312, all the narrow links including the narrow link 330 are made to enter an unused (disabled) state. In other words, the third expander 312 is activated in a state where the narrow link 330 is cut off.

Next, FIG. 11 shows another connection diagram between an upper-side interface substrate and an expander substrate. When the narrow link 342 and the wide link 340 are used as routes forming paths in the second disk unit 18 in FIG. 11, the narrow link 342 and the wide link 340 are collectively treated as one port. As a result, even if the narrow link 342 and the wide link 340 are used as the routes forming the paths, this will not cause a violation of the SAS standards.

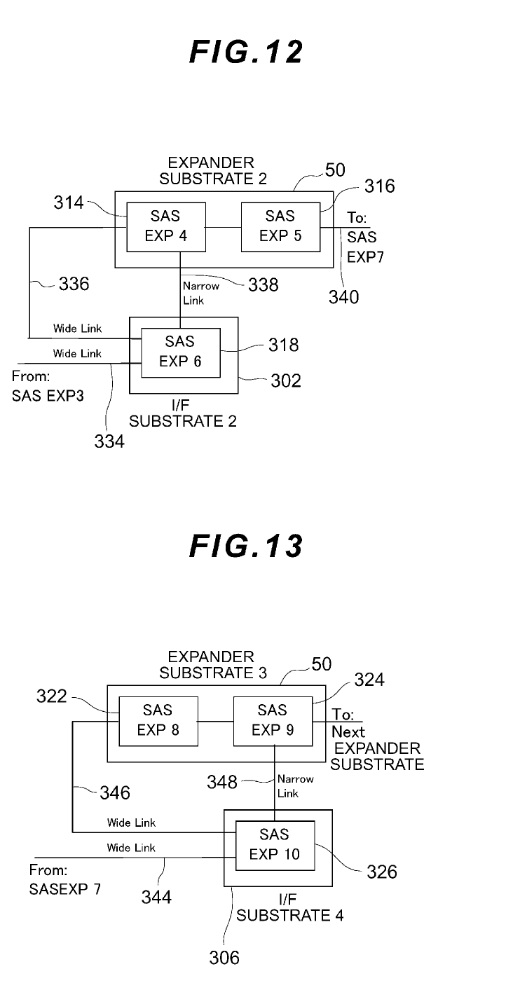

Next, FIG. 12 shows a connection diagram between a lower-side interface substrate and an expander substrate. When the narrow link 338 and the wide link 336 are used as routes forming paths in the second disk unit 18 in FIG. 12, the narrow link 338 and the wide link 336 are collectively treated as one port. As a result, even if the narrow link 338 and the wide link 336 are used as the routes forming the paths, this will not cause a violation of the SAS standards.

FIG. 13 shows another connection diagram between a lower-side interface substrate and an expander substrate. If the narrow link 348 and the wide link 346 are used as routes forming paths in FIG. 13, the SAS routing in the loop shape is formed, thereby causing a violation of the SAS standards. Therefore, when activating the tenth expander 326, all the narrow links including the narrow link 348 are made to enter an unused (disabled) state. In other words, the tenth expander 326 is activated in a state where the narrow link 348 is cut off.

In the process of executing the initialization processing on the upper-side interface substrate and the lower-side interface substrate, the cable type is identified and settings to, for example, set a signal waveform are made. The settings are realized by using a register contained in each copper connector or optical connector.

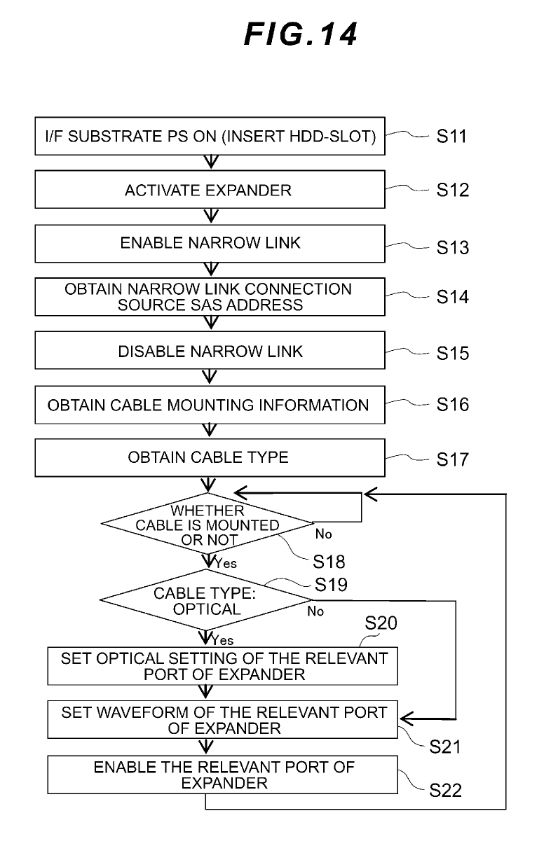

Next, the processing for initializing each interface substrate will be explained with reference to a flowchart in FIG. 14.

Firstly, when the interface substrate is inserted into the HDD slot, for example, in a case of the system configuration shown in FIG. 9, power is supplied from the power source unit 82 to each interface substrate 300, 302, 304, 306 (S11). Subsequently, the expander 312, 318, 320, 326 mounted on each interface substrate 300, 302, 304, 306 is activated in a state where all ports are set to the unused state (disabled state) (S 12). For example, at the time of activation, each expander 312, 318, 320, 326 loads an initialization file from a flash memory (not shown) mounted on the interface substrate 300, 302, 304, 306 and then all the ports are set to the unused state (disabled state) and each expander is activated based on the loaded initialization file.

Next, each expander 312, 318, 320, 326 sets only the narrow link to a used state (enabled state) in order to obtain the SAS address which is set to each expander 308, 314, 316, 324 (S 13).

Then, each expander 312, 318, 320, 326 obtains a connection-target SAS address via the narrow link (S14). For example, the expander 312 obtains the SAS address of the first expander 308.

Subsequently, each expander 312, 318, 320, 326 sets the narrow link to the disabled state (S15). Then, each expander 312, 318, 320, 326 accesses the register of each connector mounted on each expander and obtains cable mounting information from each register (S 16), and obtains the cable type of the cable connected to each connector from the obtained cable mounting information (S 17).

Next, each expander 312, 318, 320, 326 judges whether or not the cable is mounted on the interface substrate, based on the obtained cable mounting information (S 18). If each expander 312, 318, 320, 326 determines in step S18 that no cable is mounted on the substrate, the relevant connector connection port is in a standby state; if each expander 312, 318, 320, 326 determines in step S18 that the cable is mounted on the interface substrate, the expander 312, 318, 320, 326 judges whether the cable type of the cable mounted on the interface substrate is an optical cable or not (S 19).

If it is determined in step S19 that the cable type is the optical cable, each expander 312, 318, 320, 326 sets the relevant connector connection port as a port for the optical cable (S20) and sets the waveform of the relevant connector connection port to match the optical cable (S21).

On the other hand, if it is determined in step S19 that the cable type is not the optical cable, that is, if it is determined that the cable type is a copper cable, the protocol setting is unnecessary, so that each expander 312, 318, 320, 326 sets the waveform of the relevant connector connection port to match the copper cable (S21).

Subsequently, each expander 312, 318, 320, 326 sets each port, to which the cable is connected, to the enabled state (S22), and then proceeds to the processing in step S18 and repeats the processing in steps S18 to S22.

Incidentally, in step S21, settings such as pre-emphasis adjustment and signal amplification are also made.

Furthermore, from step S18 to step S22, polling processing is executed for each cable connection port; and various settings are always executed when connecting a cable. Furthermore, when the cable is removed from the substrate and a link down occurs, power consumption can be reduced by the expander setting the port to the disabled state.

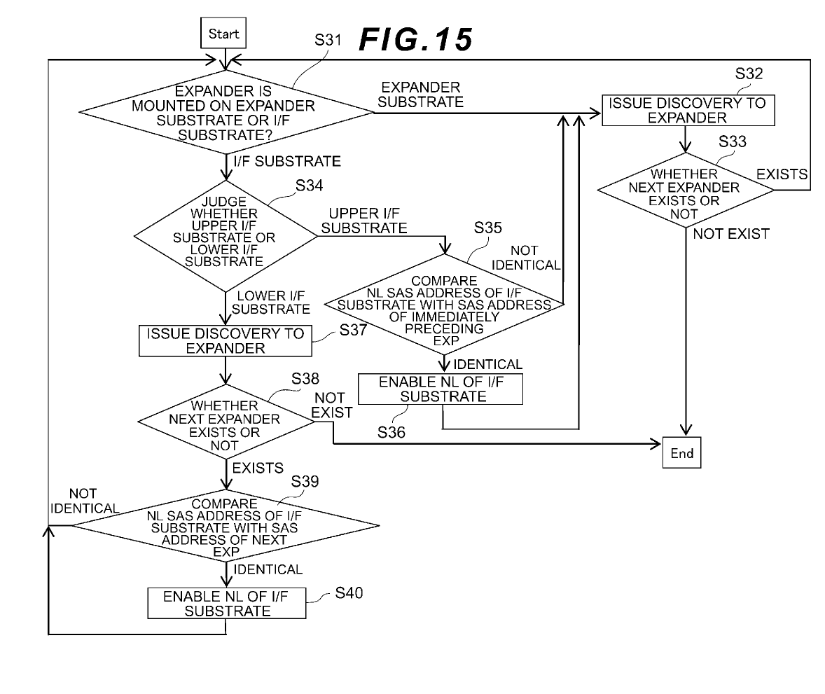

Next, the processing in the system configuration shown in FIG. 9 will be explained with reference to a flowchart in FIG. 15. In this processing, a discovery (discovery command) is issued from the SAS controller 48 to each expander 308 to 326 in order to examine a connection status of each expander 308 to 326 and the interface substrates 300 to 306. Under this circumstance, each expander 308 to 326 processes the discovery command and records the processing result in a routing table.

Firstly, the system (main software managed by the disk controller 16) judges whether an expander directly connected to the SAS controller 48, that is, the first expander 308 is mounted on either the expander substrate or the interface substrate (S31). Incidentally, a discovery is issued for each port; however, the following explanation will be given, assuming that the discovery is issued to all ports of the expanders.

Since it is determined based on the SAS address that the first expander 308 is mounted on the first expander substrate 50, the system issues a discovery to the first expander 308 (S32). The system judges, based on the discovery result, whether an expander connected to the first expander 308 exists or not (S33). In this case, it is determined the first expander 308 is connected to the second expander 310, so that the processing returns to the processing in step S31 and the system judges whether or not the second expander 310 is mounted on the expander substrate or the interface substrate. Incidentally, the third expander 312 is connected to the first expander 308 via the narrow link 330; however, since the third expander 312 sets the narrow link 330 to the disabled state, the first expander 308 will not recognize the third expander 312 as a connection-target expander.

Since it is determined in step S31 that the second expander 310 is mounted on the first expander substrate 50, the system issues a discovery to the second expander 310 (S32).

Next, the system judges whether an expander connected to the second expander 310 exists or not, based on the discovery result (S33). In this case, it is determined that that the third expander 312 is connected to the second expander 310, so that whether or not the third expander 312 is mounted on the expander substrate or the interface substrate is judged in step S31. In this case, since the third expander 312 is mounted on the first interface substrate 300, it is determined that the third expander 312 is mounted on the interface substrate; and then whether the interface substrate on which the third expander 312 is mounted is an upper-side interface substrate or a lower-side interface substrate is judged (S34).

If it is determined in step S34 that the third expander 312 is mounted on the upperside interface substrate, the system compares a SAS address of the expander connected via the narrow link to the third expander 312, that is, the first expander 308, with a SAS address of the immediately preceding expander, that is, the second expander 310 (S35). In this case, the narrow link SAS address is the SAS address of the first expander 308. So, it is determined that the narrow link SAS address is not identical to the SAS address of the second expander; and the processing proceeds to the processing in step S32.

In step S32, the system issues a discovery to the third expander 312. According to the discovery result, the sixth expander 318 is connected to the third expander 312 and the sixth expander 318 is mounted on the interface substrate 302. So, it is then determined in step S34 that the sixth expander 318 is mounted on the lower-side interface substrate. Specifically speaking, the second interface substrate 302 on which the sixth expander 318 is mounted is located next to the interface substrate 300, is the interface substrate detected the second time, and is the interface substrate detected the even-numbered time, so that the second interface substrate 302 is determined to be the lower-side interface substrate.

Subsequently, the system issues a discovery to the sixth expander 318 (S37).

Next, the system judges whether an expander connected to the sixth expander 318 exists or not (S38). Since the sixth expander 318 is connected to the fourth expander, the system compares a SAS address of the expander connected via the narrow link to the sixth expander 318, that is, the fourth expander 314, with a SAS address of the next expander, that is, the fourth expander 314 (S39). In this case, since both the compared expanders are the fourth expander and their SAS addresses are identical to each other, the comparison result shows that these addresses are identical to each other. Subsequently, the system sets the narrow link for the sixth expander 318 to the enabled state (S40) and returns to the processing in step S31.

Then, the processing from step S31 to step S40 continues in the same manner until an expander exists as a SAS device; and the connection status of each expander is recorded in the routing table.

Incidentally, in step S36, processing for setting the narrow link for the expander 320, which is mounted on the upper-side interface substrate, to the enabled state is executed.

In the process of executing the above-described processing, the narrow links 338, 342 can be used as paths by setting the narrow links 338, 342 to the enabled state, thereby improving the performance. Furthermore, even if the wide link 336 or the wide link 340 is disconnected, degeneracy operation can be performed by using the narrow links 338, 342, thereby avoiding system failures such as a path blockage.

Furthermore, since the storage device 54 has two ports, it is possible to switch from a path using one port to a path using the other port via the interface substrate 302 or the interface substrate 304 by setting the narrow links 338, 342 to the enabled state; and, therefore, it is possible to flexibly deal with not only usual operation, but also processing at the time of a failure.

According to this embodiment, the difference in the form of connectors connected to data transmission cables can be absorbed and the following advantageous effects can be obtained.

(1) An optical cable can be used without using a copper cable. Meanwhile, if the optical cable is used, the disk unit 18 can be installed without any restriction on the cable length.

(2) Since an interface substrate can be used even if the existing expander substrate or the HDD slot is used, the present invention can be applied to the existing disk array apparatus.

(3) Even if the optical cable is used, the cost can be minimized by placing the interface substrate 120 only at the location where the optical cable is required.

(4) If the optical cable is used, noise and electrostatic strength will improve more than the case where the copper cable is used; and the quality as the disk array apparatus can be enhanced.

(5) The difference in the shape of connectors, whether the copper cable or the optical cable, can be absorbed and a flexible device configuration can be constructed.

(6) The present invention can be also applied to the existing disk array apparatus by changing the connector of the interface substrate according to the shape of the connector to be connected to the cable with respect to not only cables provided at present, but also cables to be developed in the future.

(7) Even if a failure occurs in the cable, access can be made to a downstream path via the narrow link by using a combination of the wide link, which is a cable connection, and the narrow link.

### Second Embodiment

This embodiment is designed to share one interface substrate as an upper-side interface substrate or a lower-side interface substrate.

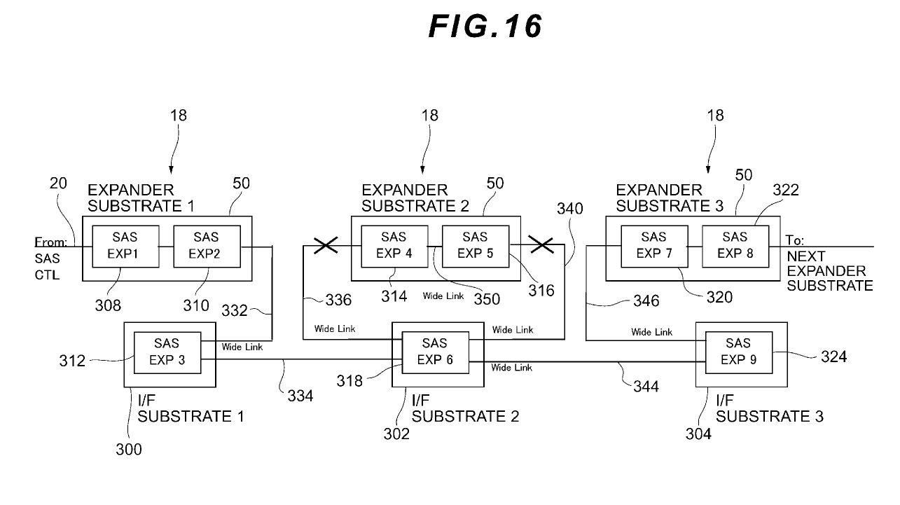

FIG. 16 shows a system configuration diagram according to the second embodiment.

Referring to FIG. 16, a first disk unit 18 is composed of a first expander substrate 50 and a first interface substrate 300. A second disk unit 18 is composed of a second expander substrate 50 and a second interface substrate 302. A third disk unit 18 is composed of a third expander substrate 50 and a third interface substrate 304.

The first expander substrate 50 is equipped with a first expander 308 and a second expander 310; and the interface substrate 300 is equipped with a third expander 312. The second expander substrate 50 is equipped with a fourth expander 314 and a fifth expander 316. The second interface substrate 302 is equipped with a sixth expander 318. Furthermore, the third expander substrate 50 is equipped with a seventh expander 320 and an eighth expander 322; and the third interface substrate 304 is equipped with a ninth expander 324.

The first expander 308 is connected via the copper cable 20 to the SAS controller 48; and the second expander 310 is connected via the wide link 332 to the third expander 312. The third expander 312 is connected via the wide link 334 to the sixth expander 318. The sixth expander 318 is connected via the wide link 336 to the fourth expander 314. The fifth expander 316 is connected via the wide link 340 to the sixth expander 318. Furthermore, the sixth expander 318 is connected via the wide link 344 to the ninth expander 324. The ninth expander 324 is connected via the wide link 346 to the seventh expander 320. Incidentally, narrow links are set to the disabled state for the sake of simplification and their illustration is omitted.

If in the above-described configuration the sixth expander 318 and the fourth expander 314 are connected via the wide link 336, and the fourth expander 314 and the fifth expander 316 are connected via the wide link 350, and the sixth expander 318 and the fifth expander 316 are connected via the wide link 340, SAS routing in a loop shape by the wide link 336 and the wide link 340 is formed, thereby causing a violation of the SAS standards. Specifically speaking, if the interface substrate 302 is shared by the fourth expander 314 and the fifth expander 316, this will cause a violation of the SAS standards. Therefore, enable processing or disable processing is executed at the time of initialization of the interface substrate 302 with respect to the sixth expander 318 mounted on the interface substrate 302 in order to prevent the violation of the SAS standards.

For example, at the time of initialization of the second interface substrate 302, only the wide link 336 is set to the enabled state and the wide link 350 connecting the fourth expander 314 and the fifth expander 316 is set to the disabled state. Then, the violation of the SAS standards can be avoided by setting the wide link 340 to the enabled state. In other words, the violation of the SAS standards can be avoided by cutting off the wide link 350. In this case, the fourth expander 314, the fifth expander 316, and the ninth expander 324 are connected in parallel to the sixth expander 318.

Therefore, for example, when the SAS controller 48 accesses the fifth expander 316, the fifth expander 316 can be accessed via the first expander 308, the second expander 310, the third expander 312, and the sixth expander 318, but not accessing the fifth expander 5 via the first expander 308, the second expander 310, the third expander 312, the sixth expander 318, and the fourth expander 314. So, delay at the time of access can be avoided and the performance can be enhanced.

Furthermore, the second interface substrate 302 is shared by the fourth expander 314 and the fifth expander 316, a used amount of the HDD slots for inserting the interface substrates reduces, thereby making it possible to minimize a reduction of the storage capacity of the disk array apparatus as a whole.

Also, the violation of the SAS standards can be avoided merely by setting only one of the wide link 336 and the wide link 340 to the enabled state and setting the other wide link to the disabled state.

For example, if the wide link 336 is set to the enabled state and the wide link 340 is set to the disabled state, the fourth expander 314 and the ninth expander 324 are connected in parallel to the sixth expander 318 and each of them is connected to the lower side of the fifth expander 316 and the seventh expander 320. Also in this case, access to the expander located on the lower side from the ninth expander 324 can be made not through the fourth expander 314 or the fifth expander 316, so that delay at the time of access can be avoided and the performance can be enhanced.

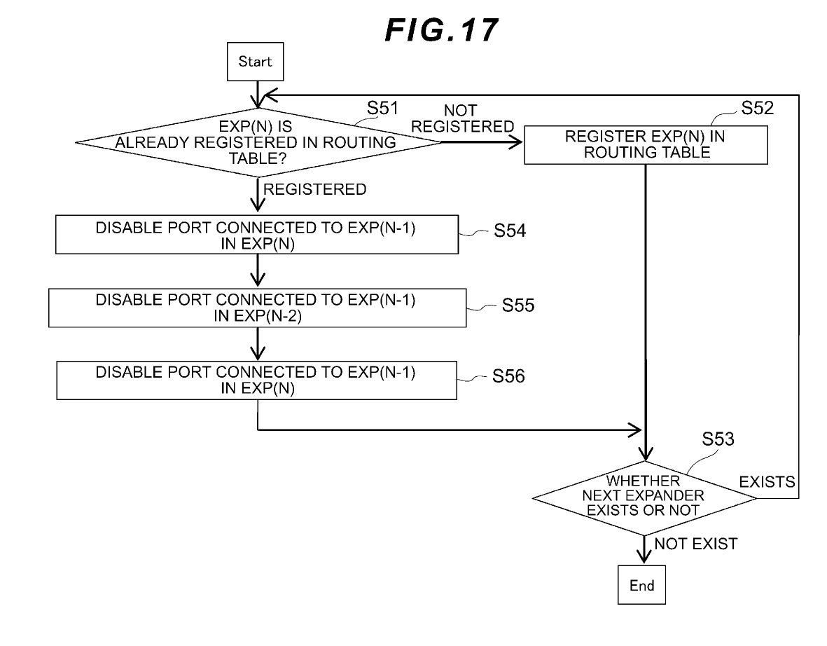

Next, processing in this embodiment will be explained with reference to a flowchart in FIG. 17. Firstly, the system judges whether or not information of the first expander 308 connected to the controller 48 is registered in the routing table of that SAS controller 48 (S51). Since information of all the expanders is not registered at the beginning, the system registers the first expander 308 in the routing table of the SAS controller 48 (S52) and then judges whether an expander connected to the first expander 308 exists or not (S53).

Then, since the second expander, which is located on the lower side from the local expander, to the first expander 308, the system judges whether or not the second expander 310 is registered in the routing table (S51). In this case, since the second expander 310 is not registered in the routing table, the system registers the second expander in the routing table (S52) and judges whether a connection target expander exists or not (S53).

In this case, after the third expander 312, the sixth expander 318, the fourth expander 314, and the fifth expander 316 are registered in the routing table, whether or not the information of the sixth expander 318 is registered in the routing table is judged again in step S51.

In this case, the information of the sixth expander 318 is already registered in the routing table, so that in step S54, a port of the wide link 340 connecting the sixth expander 318 and the fifth expander 316 is set to the disabled state (S54). Next, a port of the wide link 350 connecting the fourth expander (second expander before the sixth expander 318) 314 and the fifth expander (expander immediately preceding the sixth expander) 316 is set to the disabled state (S55).

Next, a port of the wide link 340 connecting the sixth expander 318 and the fifth expander 316 are set to the enabled state (S56).

Specifically speaking, on condition that the wide link 350 is in a cut-off state, the wide link 340 is set to the enabled state. Then, the processing of step S53 is executed. Subsequently, processing for registering the information of the ninth expander 324, the seventh expander 320, and the eighth expander 322 in the routing table is executed.

As a result of the above-described processing, the violation of the SAS standards can be avoided by cutting off the wide link 350 and then setting the wide link 336 and the wide link 340 to the enabled state.

According to this embodiment, the same advantageous effects as those of the first embodiment can be obtained and one interface substrate 302 can be shared as the upper-side interface substrate or the lower-side interface substrate; and even if there is a shortage of empty HDD slots, one interface substrate 302 can be utilized effectively as the upper-side interface substrate or the lower-side interface substrate.

### Third Embodiment

This embodiment is designed to avoid the violation of the SAS standards without cutting off wide links connecting the respective expanders on expander substrates even when a plurality of expanders are mounted on an expander substrate connected to an interface substrate used as an upper-side interface substrate or a lower-side interface substrate.

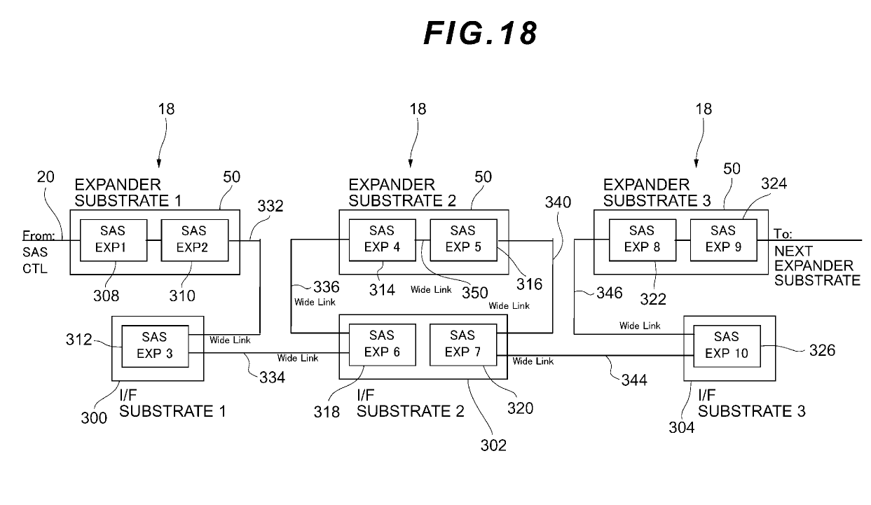

FIG. 18 shows a system configuration diagram according to a third embodiment. Referring to FIG. 18, a first disk unit 18 is composed of a first expander substrate 50 and a first interface substrate 300. A second disk unit 18 is composed of a second expander substrate 50 and a second interface substrate 302. A third disk unit 18 is composed of a third expander substrate 50 and a third interface substrate 304.

The first expander substrate 50 is equipped with a first expander 308 and a second expander 310; and the first interface substrate 300 is equipped with a third expander 312. The second expander substrate 50 is equipped with a fourth expander 314 and a fifth expander 316. The second interface substrate 302 is equipped with a sixth expander 318 and a seventh expander 320. Furthermore, the third expander substrate 50 is equipped with an eighth expander 322 and a ninth expander 324, and the third interface substrate 304 is equipped with a tenth expander 326.

The first expander 308 is connected via the copper cable 20 to the SAS controller 48; and the second expander 310 is connected via the wide link 332 to the third expander 312. The third expander 312 is connected via the wide link 334 to the sixth expander 318. The sixth expander 318 is connected via the wide link 336 to the fourth expander 314. The fifth expander 316 is connected via the wide link 340 to the seventh expander 320. Furthermore, the seventh expander 318 is connected via the wide link 344 to the tenth expander 326. The tenth expander 326 is connected via the wide link 346 to the eighth expander 322. Incidentally, narrow links are set to the disabled state for the sake of simplification and their illustration is omitted.

Even if in the above-described configuration the sixth expander 318 and the fourth expander 314 are connected via the wide link 336 and the fifth expander 316 and the seventh expander 320 are connected via the wide link 340 in a state where the fourth expander 314 and the fifth expander 316 are connected via the wide link 350, the wide link 336 and the wide link 340 are connected to respectively different expanders, so that the SAS routing of the loop shape will not be formed.

According to this embodiment, the sixth expander 318 and the seventh expander 320 are independently placed on the interface substrate 302 without cutting off the wide link 350, so that it is possible to avoid the violation of the SAS standards and it is unnecessary to execute the processing shown in FIG. 7 and the processing can be simplified.

Incidentally, the aforementioned embodiments have been described in detail in order to explain the invention in an easily comprehensible manner and are not necessarily limited to those having all the configurations explained above. Furthermore, part of the configuration of a certain embodiment can be replaced with the configuration of another embodiment and the configuration of another embodiment can be added to the configuration of a certain embodiment.

For example, if the copper cable 106 is used instead of the optical cable 106 in FIG. 3, the difference in the shape of copper connectors can be absorbed by using any one of the interface substrates 170, 180, 190, 200 as the interface substrate 96, 102.

Furthermore, if the first disk unit 18 and the second disk unit 18 are connected via a copper cable in FIG. 3, the difference in the shape of copper connectors can be absorbed by using any one of the interface substrates 170, 180, 190, 200, for example, the interface substrate 170 as the interface substrate 96, connecting the copper cable 104 and a copper connector of the interface substrate 170, and connecting the copper connector of the interface substrate 170 and the copper cable 108.

Furthermore, part or all of the aforementioned configurations, functions, and so on may be realized by hardware by, for example, designing them in integrated circuits. Also, each of the aforementioned configurations, functions, and so on may be realized by software by processors interpreting and executing programs for realizing each of the functions. Information such as programs, tables, and files for realizing each of the functions may be recorded and retained in memories, storage devices such as hard disks and SSDs (Solid State Drives), or storage media such as IC (Integrated Circuit) cards, SD (Secure Digital) memory cards, and DVDs (Digital Versatile Discs).

### REFERENCE SIGNS LIST

10 Host (host computer)
12 Disk array apparatus
16 Disk controller
18 Disk unit
24, 26 Host interface substrates
28, 30 Switch substrates
32, 34 MP substrates
36, 38 Shared memory substrates
40, 42 HDD control substrates
50, 52 Expander substrates
54 Storage devices
92, 94, 98, 100 Expanders
134, 136 Copper connectors
138, 140 Optical connectors
300, 302, 304, 306 Interface substrates
308, 310, 312, 314, 316, 318, 320, 322, 324, 326 Expanders

1. A disk array apparatus comprising:
a disk controller for sending and receiving information to and from a host computer and executing data input/output processing in accordance with a control command from the host computer; and
a plurality of disk units including one or more control units for executing data input/output processing on a storage device in accordance with a control command from the disk controller and controlling data transfer to the storage device or the disk controller, the respective disk units being serially connected to each other via any one of a plurality of data transmission cables;
wherein one or more interface substrates for relaying data moving between adjacent disk units is placed in at least one disk unit among the plurality of disk units;
wherein the interface substrate has a plurality of cable connection connectors connected to the data transmission cable;
wherein a first cable connection connector among the plurality of cable connection connectors is connected to a local disk unit, in which the first cable connection connector is placed, among the plurality of disk units via a first data transmission cable;
wherein a second cable connection connector among the plurality of cable connection connectors is connected to an adjacent disk unit, which is located adjacent to the local disk unit among the plurality of disk units, or to an interface substrate, which is placed in the adjacent disk unit, via a second data transmission cable; and
wherein the respective cable connection connectors are configured as connectors in mutually different forms.

2. The disk array apparatus according to claim 1, wherein if a signal using the first cable connection connector as a transmission medium and a signal using the second cable connection connector as a transmission medium are of the same type, the first cable connection connector and the second cable connection connector are configured in mutually different shapes.

3. The disk array apparatus according to claim 1, wherein the interface substrate has a protocol converter for converting a signal input from the first cable connection connector from a protocol for an electric signal to a protocol for an optical signal or from the protocol for the optical signal to the protocol for the electric signal and outputting the converted signal to the second cable connection connector or converting a signal input from the second cable connection connector from the protocol for the electric signal to the protocol for the optical signal or from the protocol for the optical signal to the protocol for the electric signal and outputting the converted signal to the first cable connection connector.

4. The disk array apparatus according to claim 1, wherein the interface substrate has a signal amplifier for amplifying a signal input from the first cable connection connector and outputting the amplified signal to the second cable connection connector or and for amplifying a signal input from the second cable connection connector and outputting the amplified signal to the first cable connection connector.

5. The disk array apparatus according to claim 1, wherein the interface substrate has, in addition to the first cable connection connector and the second cable connection connector, a third cable connection connector and a fourth cable connection connector as connectors sharing the interface substrate; and
wherein if the first cable connection connector is connected to a first control unit among a plurality of control units for the local disk unit via the first data transmission cable, and
if the second cable connection connector is connected to an interface substrate placed in an upper-side adjacent disk unit, which is located closer to the disk controller than to the local disk unit among the adjacent disk units, via the second data transmission cable, and
if the third cable connection connector is connected to a second control unit among the plurality of control units for the local disk unit via a third data transmission cable, and
if the fourth cable connection connector is connected to an interface substrate placed in a lower-side adjacent disk unit, which is located farther from the disk controller than from the local disk unit among the adjacent disk units, via a fourth data transmission cable,
the first data transmission cable and the third data transmission cable constitute a data transmission path on condition that a wide link connecting the first control unit and the second control unit to each other is cut off.

6. The disk array apparatus according to claim 1, wherein the interface substrate has, in addition to the first cable connection connector and the second cable connection connector, a third cable connection connector and a fourth cable connection connector as connectors sharing the interface substrate; and
wherein if the first cable connection connector is connected to a first control unit among a plurality of control units for the local disk unit via the first data transmission cable, and
if the second cable connection connector is connected to an interface substrate placed in an upper-side adjacent disk unit, which is located closer to the disk controller than to the local disk unit among the adjacent disk units, via the second data transmission cable, and
if the third cable connection connector is connected to a second control unit among the plurality of control units for the local disk unit via a third data transmission cable, and
if the fourth cable connection connector is connected to an interface substrate placed in a lower-side adjacent disk unit, which is located farther from the disk controller than from the local disk unit among the adjacent disk units, via a fourth data transmission cable, and
if the first control unit and the second control unit are connected via a wide link,
either the first data transmission cable or the third data transmission cable constitutes a data transmission path.

7. The disk array apparatus according to claim 1, wherein the interface substrate includes:
a third cable connection connector and a fourth cable connection connector as connectors sharing the interface substrate in addition to the first cable connection connector and the second cable connection connector;
a first protocol converter for converting a signal input from the first cable connection connector from a protocol for an electric signal to a protocol for an optical signal or from the protocol for the optical signal to the protocol for the electric signal and outputting the converted signal to the second cable connection connector or converting a signal input from the second cable connection connector from the protocol for the electric signal to the protocol for the optical signal or from the protocol for the optical signal to the protocol for the electric signal and outputting the converted signal to the first cable connection connector; and
a second protocol converter for converting a signal input from the third cable connection connector from a protocol for an electric signal to a protocol for an optical signal or from the protocol for the optical signal to the protocol for the electric signal and outputting the converted signal to the fourth cable connection connector or converting a signal input from the fourth cable connection connector from the protocol for the electric signal to the protocol for the optical signal or from the protocol for the optical signal to the protocol for the electric signal and outputting the converted signal to the third cable connection connector; and
wherein the first cable connection connector is connected to a first control unit among a plurality of control units for the local disk unit via the first data transmission cable;
the second cable connection connector is connected to an interface substrate placed in an upper-side adjacent disk unit, which is closer to the disk controller than to the local disk unit, among the adjacent disk units, via the second data transmission cable;
the third cable connection connector is connected to a second control unit among the plurality of control units for the local disk unit via a third data transmission cable; and
the fourth cable connection connector is connected to an interface substrate placed in a lower-side adjacent disk unit, which is located farther from the disk controller than from the local disk unit among the adjacent disk units, via a fourth data transmission cable.

8. The disk array apparatus according to claim 1, wherein the interface substrate has a protocol converter for converting a signal input from the first cable connection connector from a protocol for an electric signal to a protocol for an optical signal or from the protocol for the optical signal to the protocol for the electric signal and outputting the converted signal to the second cable connection connector or converting a signal input from the second cable connection connector from the protocol for the electric signal to the protocol for the optical signal or from the protocol for the optical signal to the protocol for the electric signal and outputting the converted signal to the first cable connection connector; and
wherein if a first control unit among a plurality of control units for the local disk unit, in which the first cable connection connector is placed, is connected to the protocol converter via a narrow link and a second control unit among the plurality of control units for the local disk unit is connected to the first cable connection connector via the first data transmission cable constituting a wide link,
the first data transmission cable is used as a data transmission path on condition that the narrow link is cut off.

9. The disk array apparatus according to claim 1, wherein the interface substrate has a protocol converter for converting a signal input from the first cable connection connector from a protocol for an electric signal to a protocol for an optical signal or from the protocol for the optical signal to the protocol for the electric signal and outputting the converted signal to the second cable connection connector or converting a signal input from the second cable connection connector from the protocol for the electric signal to the protocol for the optical signal or from the protocol for the optical signal to the protocol for the electric signal and outputting the converted signal to the first cable connection connector; and
wherein if a first control unit among a plurality of control units for the local disk unit, in which the first cable connection connector is placed, is connected to the first cable connection connector via the first data transmission cable constituting a wide link and a second control unit among the plurality of control units for the local disk unit is connected to the protocol converter via a narrow link,
the first data transmission cable is used as a data transmission path on condition that the narrow link is cut off.

10. The disk array apparatus according to claim 1, wherein the interface substrate has a protocol converter for converting a signal input from the first cable connection connector from a protocol for an electric signal to a protocol for an optical signal or from the protocol for the optical signal to the protocol for the electric signal and outputting the converted signal to the second cable connection connector or converting a signal input from the second cable connection connector from the protocol for the electric signal to the protocol for the optical signal or from the protocol for the optical signal to the protocol for the electric signal and outputting the converted signal to the first cable connection connector; and
wherein if a lower-side first control unit among a plurality of control units for the local disk unit, in which the first cable connection connector is placed, is connected to the protocol converter via a narrow link and to the first cable connection connector via the first data transmission cable constituting a wide link,
the first data transmission cable is used as a data transmission path on condition that the narrow link and the wide link constitute a link to be connected to one port.

11. The disk array apparatus according to claim 1, wherein the interface substrate has a protocol converter for converting a signal input from the first cable connection connector from a protocol for an electric signal to a protocol for an optical signal or from the protocol for the optical signal to the protocol for the electric signal and outputting the converted signal to the second cable connection connector or converting a signal input from the second cable connection connector from the protocol for the electric signal to the protocol for the optical signal or from the protocol for the optical signal to the protocol for the electric signal and outputting the converted signal to the first cable connection connector; and
wherein if an upper-side first control unit among a plurality of control units for the local disk unit, in which the first cable connection connector is placed, is connected to the protocol converter via a narrow link and to the first cable connection connector via the first data transmission cable constituting a wide link,
the first data transmission cable is used as a data transmission path on condition that the narrow link and the wide link constitute a link to be connected to one port.

12. The disk array apparatus according to claim 1, wherein the interface substrate has one or more wide links to connect a pair of cable connection connectors to each other among the plurality of cable connection connectors.
